(19) United States
(12) Patent Application Publication
(10) Pub. No.: US 2012/0310407 A1
(43) Pub. Date: Dec. 6, 2012

(54) VENDING MACHINE CONTROL

(75) Inventors: Michael David De La Rue, Warszawa (PL); Abhinav Singh, Gold Coast (SG); Boby Kj, Kerala (IN); Maciej Gulak, Jozefoslaw (PL); Manuel Nakamurakare, Bellavista (PE); Marco Aurelio da Costa Soeima, Santo Antonio dos Cavaleiros (PT)

(73) Assignee: NOKIA SIEMENS NETWORKS OY, Espoo (FI)

(21) Appl. No.: 13/151,437

(22) Filed: Jun. 2, 2011

(51) Int. Cl. G06F 17/00

(52) U.S. Cl. 700/225

(57) ABSTRACT

The present invention relates to methods and apparatus for controlling a vending machine. A product that is next to be dispensed in a vending machine is identified and the expiry date of the product is determined. One or more corrective actions are triggered if the current date is within a predefined time period of the expiry date of the product.

The present invention relates to vending machine control and, in particular, to vending machine control in respect of products expiry dates.

Presently there are a substantial number of vending machines (most likely in the order of millions of vending machines) that are installed in numerous locations around the world. Vending machines are typically a machine that vends, or dispenses, products to customers usually after the customer has selected the product they desire and provided some form of payment.

Vending machines vary in complexity and automation. More simplistic vending machines stored a single product and the customer inserted a coin and rotated or pulled a handle in order to retrieve the product. Examples of simple vending machines are the gum ball (or other sweet) machines and the newspaper boxes. However, modern vending machines are more complex containing multiple different types of products, having electronic control mechanisms, requiring environmental control (e.g. cooling), and so on. Examples of more modern vending machines are the snack machines that vend different types of food (e.g. crisps, drinks, chocolate, and so on), cigarettes, etc.

Vending machines that vend or dispense perishable goods, such as food, snacks, drinks, etc., have to be careful to ensure that the perishable goods are within the expiry date or best-before date if the goods in the vending machine. Typically, the owner of the vending machine or the stockist for the vending machine will have to physically go to the vending machine and check the perishable goods to see if they are within their expiry date. The stockist often carries additional stock which may or may not be required if the goods have, or have not been sold or if the goods are or are not within their expiry dates.

As such, time, money and an increased carbon footprint occurs by the stockist travelling to each and all of the vending machines in order to inspect and replace unusable goods that are outside of their expiry date. Also, goods that may be out-of-date may still be inside the vending machine if not checked carefully or often enough by the stockist. Therefore a customer may receive out-of-date goods which may have health issues or upset the customer such that the customer no longer uses the vending machine.

Thus, the present invention aims to overcome, at least in part, any or all of the drawbacks and/or problems described hereinabove.

According to a first aspect of the present invention there is provided a method comprising the steps of: identifying a first product that is next to be dispensed in a vending machine; determining an expiry date of the first product; and triggering one or more first corrective actions if current date is within a predefined time period of the expiry date of the first product.

The method may be implemented by a server, by the vending machine or any combination thereof. The vending machine may have several products that are next to be dispensed, as next to be dispensed may refer to a product that may be selected and/or purchased from the vending machine by a customer. Based on the expiry date of a product to be dispensed next in the vending machine it may be determined if the current date, e.g. the date when the product is next to be dispensed, is within a predefined time period of the expiry date. If the product is within the predefined time period of its expiry date then one or more corrective actions may be triggered.

The expiry date of the next product to be dispensed may be identified from a database or other record and based on the identified product the expiry date may be obtained from the database.

The predefined time period may be one time period for all products in the vending machine. There may be different time period predefined for different products.

There may be any number of corrective actions that may be defined and triggered if it is determined that the next product to be dispensed is within the predefined time period of the expiry date of the product. The corrective actions may be maintained in a database.

The step of identifying the first product to be dispensed may comprise the steps of: receiving an initial position of the first product in the vending machine; receiving information on one or more second products dispensed in the vending machine; and tracking a position of the first product based on the received information on one or more of the second products.

Therefore, the next product to be dispensed may be identified by tracking the position of the product in the vending machine. The initial position of a product may be received, for example, via a device used by a stockist of the vending machine to record the initial position of the product. Information relating to the products dispensed from the vending machine may be recorded and may be received. The information may be received in real-time or periodically. The information may enable the position of a product to be tracked from their initial position by taking into account when products in front of the product are dispensed.

The step of identifying the first product to be dispensed may comprise the step of receiving an identification of the first product from the vending machine when the first product is next to be dispensed. Therefore, in order to identify the next product to be dispensed an identification of the product may be received from the vending machine. For example, the vending machine may comprise one or more Near Field Communication (NFC) readers which can read a corresponding NFC tag on the product that is next to be dispensed in the vending machine where the NFC tag may include, for example, an identification of the product such as a unique serial number of the product.

The method may further comprise the step of identifying the one or more first corrective actions to trigger based on one or more predefined first criteria. The predefined criteria may be any criteria, for example, the criteria may relate to the product, the type of product, the amount of time before the expiry date of a product, and so on. Thus, the one or more corrective actions may be identified depending on the criteria. For example, corrective actions may include reducing the price of the product, providing an offer in relation to the product, and so on.

The method may further comprise the step of triggering one or more second corrective actions if current date is after the expiry date of the first product. The method may further comprise identifying the one or more second corrective actions to trigger based on one or more predefined second criteria.

Therefore, it may be determined whether the current date of the product next to be dispensed is after the expiry date of the product. If so, one or more corrective actions may be triggered based on predefined criteria, for example, the vending machine may be instructed to prevent the sale of the product, may instruct the vending machine to bin the product, may communicate with a stockist system to request that the product is removed and/or replaced.

The method may further comprise the steps of periodically determining if the current date is within the predefined time period of the expiry date of the first product. The method may further comprise the steps of periodically determining if the current date is after the expiry date of the first product.

Therefore, if the first product is not dispensed from the vending machine during the first day that the first product is available to be dispensed, e.g. the next to be dispensed, then the method may determine for each day whether the current date is within the predefined time period and/or after the expiry period of the product.

According to a second aspect of the present invention there is provided an apparatus comprising: a first processor adapted to identify a first product that is next to be dispensed in a vending machine; a second processor adapted to determine an expiry date of the first product; a third processor adapted to trigger one or more corrective actions if current date is within a predefined time period of the expiry date of the first product.

According to a third aspect of the present invention there is provided an apparatus that is adapted to: identify a first product that is next to be dispensed in a vending machine; determine an expiry date of the first product; and trigger one or more first corrective actions if current date is within a predefined time period of the expiry date of the first product.

The apparatus may be adapted with hardware, software or any combination thereof. The processors adapted to indentify, determine or trigger may further be adapted to interact with inputs, outputs, memory and so on, in order to perform the functions of the aspects of the present invention.

The apparatus may further comprise a first input adapted to receive an initial position of the first product in the vending machine; a second input adapted to receive information on one or more second products dispensed in the vending machine; and a fourth processor adapted to track a position of the first product based on the received information on one or more of the second products.

The apparatus may further comprise a third input adapted to receive an identification of the first product from the vending machine when the first product is next to be dispensed.

The apparatus may further comprise a fifth processor adapted to identify the one or more first corrective actions to trigger based on one or more predefined first criteria.

The apparatus may further comprise a sixth processor adapted to trigger one or more second corrective actions if current date is after the expiry date of the first product.

The apparatus may further comprise a seventh processor adapted to identify the one or more second corrective actions to trigger based on one or more predefined second criteria.

The apparatus may further comprise an eighth processor adapted to periodically determine if the current date is within the predefined time period of the expiry date of the first product.

The apparatus may further comprise a ninth processor adapted to periodically determine if the current date is after the expiry date of the first product.

The first processor through ninth processor may be the same processor, different processors or any combination thereof.

According to a fourth aspect of the present invention there is provided a computer program product comprising computer readable executable code for: identifying a first product that is next to be dispensed in a vending machine; determining an expiry date of the first product; triggering one or more corrective actions if current date is within a predefined time period of the expiry date of the first product.

Embodiments of the present invention will now be explained, by way of example only, and with reference to the accompanying drawing, in which:

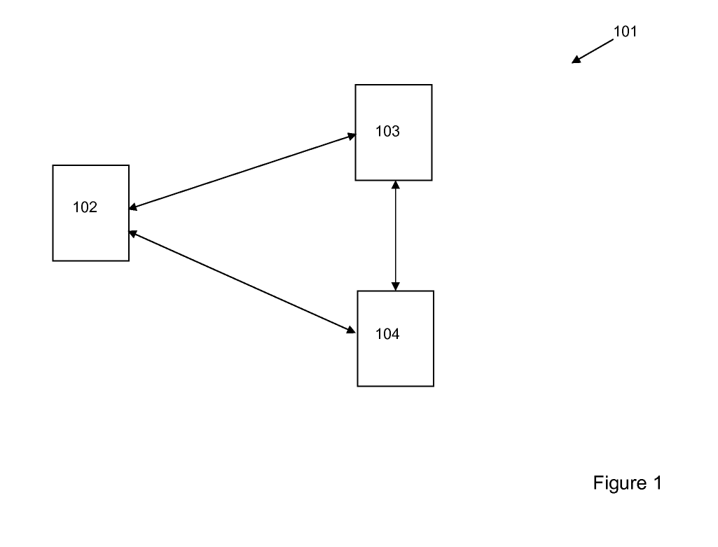

FIG. 1 shows a simplified block diagram of a system in accordance with many of the embodiments of the present invention.

Many of the embodiments of the present invention describe a system to enable tracking and maintaining perishable goods in vending machines and taking one or more corrective actions should the system identify or determine that a product in a vending machine has passed its expiry date and/or is close to the expiry date.

FIG. 1 shows a simplified block diagram of a system 101 in accordance with many embodiments of the present invention.

The system 101 may include an application 102 where the application 102 may be implemented on a computing device, e.g. a computer, a server, and so on, or the application 102 may be implemented in a vending machine 103, or the application 102 functionality may be split between the vending machine 103 and a separate device.

The application 102 may be operatively connected to one or more vending machines 103, or may be integrated with the vending machines 103, such that the application 102 may receive information or data from the vending machine 103 and/or to transmit commands to the vending machines 103.

The application 102 may further be operatively connected to a device 104 where the device 104 may be any device that may obtain or identify parameters relating to products in the vending machine 103. The device 104 may be a separate device, e.g. a device used by a stockist of the vending machine 103, may be a device integrated with the vending machine 103, or any combination thereof.

In order to obtain or identify parameters relating to a product the device 104 may include a bar code reader to read a barcode on the product, a Near Field Communication (NFC) reader to read an NFC tag on the product, and so on.

The parameters obtained or identified may include any or all of product name, product type, unique product identifier, expiry date of the product, current position of the product in the vending machine 103, initial position of the product in the vending machine 103, and so on.

The device 104 in many of the embodiments may communicate directly with the application 102, for example, via wireless communication channels, wired communication channels or any combination thereof.

Depending on the implementation of the system 101, the device 104 may be any device that can obtain or identify parameters relating to each product in the vending machine 103. For example, the stockist device 104 may be a barcode reader, a tablet device, a mobile device or any other device suitable for the purpose described herein.

The application 102 determines or identifies a product that is in a position to be vended or dispensed by the vending machine 103, for example, at the front of a row of products. The application 102 may identify the product that is in a position to be vended using one of a number of mechanisms.

One mechanism is that the device 104 may be used by a stockist to record the position in the vending machine 103 that the product is initially placed or stocked in by the stockist. For example, the device 104 may include a visual representation of the vending machine 103 enabling the stockist to input the initial position of each product being stocked and associate the initial position for each product with the product. The device 104 may therefore be a tablet with a display screen that displays the various positions in the vending machine 103, or the free positions currently in the vending machine 103. The device 104 may receive the information relating to the positions or available positions in the vending machine 103 from the application 102, or the device 104 may have a pre-installed application that includes the layout of the vending machine 103. The stockist may input the initial position for each product into the device 104, for example, the stockist may input the initial position via a touch screen, by entering co-ordinates of the initial position, e.g. row, column and depth, each position in the vending machine may have a barcode which can be read by the appropriate barcode reader, and so on.

In this example, initial position and at least an identifier of each product in the vending machine 103 may be transmitted to the application 102 such that the application 102 may track the position of each product. The application 102 may maintain a record or database of the products stocked in the vending machine 103. The database may include, for example, any of a product identifier (e.g. the product name), a unique product identifier (e.g. the product's serial number), the expiry date of the product and the product's position in the vending machine 103. When a product is stocked in the vending machine 103 the product's position will be initialised at the initial position of the product.

In this example, the database may be updated or maintained in order to monitor or track each products position in the vending machine 103. The application 102 may receive, for example in real-time, information regarding products being dispensed or vended in the vending machine 103. A unique identifier for a product that has been dispensed or vended is provided to the application 102 so that the application 102 can remove or update the entry in the database for that product. The application 102 can then also increment or update the position of each product behind the product dispensed.

Thus, the application 102 may maintain an up-to-date representation of the position of each product in the vending machine 103 thereby enabling the application 102 to identify or determine products that are next to be dispensed.

In another example, each product may be supplied with an NFC tag and the vending machine 103 may include one or more NFC readers to read or identify the NFC tag on a product that is next to be dispensed. The application 102 may then be provided with the information as to which products are next to be dispensed in the vending machine 103.

As will be appreciated, other mechanisms, or combination of mechanisms, may be implemented in order to be able to identify the products that are next to be dispensed in the vending machine.

When the application 102 identifies a product that is next to be dispensed, the application 102 may determine the products expiry date and whether the current date is within a predefined time period of the expiry date of the product or whether the current date is after the expiry date of the product.

The expiry date for the identified product may be obtained from an NFC tag on the product and/or be obtained from a database in the application 102 or operatively connected to the application 102.

The current date (e.g. the actual or real date) may be compared with the expiry date of the product to determine if the current date is within a predefined time period prior to the expiry date of the product.

The predefined time period may be a single time period defined for all products in the vending machine 103.

The predefined time period may be set for each product. In this case, the predefined time period may be associated with each individual product in the database which the application 102 may identify when obtaining the expiry date of the product.

The predefined time period may be associated with each type of product (e.g. potato products, chocolate bars, brands of products, etc) and the application 102 may maintain a list or record of the predefined time period for each type of product.

Or any combination of the predefined time periods may be implemented by the application 102.

The operator of the application 102, the vending machine 103 owner, the product manufacturer, the stockist company, the owner of the location at which the vending machine 103 is, may either or any combination thereof set predefined time periods to be implemented in the system 101.

The application 102 can then determine or identify whether the current date is within the predefined time period of the expiry date of the product.

For example, if the product is a chocolate bar with an expiry date of 20 May 2011 and if the predefined time period for the chocolate bar is two days then if the current date is 10 May 2011 the application 102 will determine that the chocolate bar is not within the predefined time period prior to expiry of the product. However, if the current date is 18 May 2011 then the application 102 will determine that the product is within the predefined time period before the expiry date of the chocolate bar.

If the application determines that the product falls within the predefined time period of its expiry date then the application 102 may trigger one or more corrective actions.

The corrective actions may be defined by the stockist, the owner of the product, the owner of the vending machine 103, the operator of the application 102, or any other party or entity that may wish to define the corrective actions. The corrective actions may be stored or maintained in a database or other structure in the application 102 or operatively attached to the application 102. The corrective actions may be associated with one or more of each product, each type of product, the amount of time prior to expiry date, and so on. As will be appreciated, any number of corrective actions may be defined and any number of corrective actions may be associated with products and based on any number of conditions or rules that may also be defined and stored in the application 102 (e.g. amount of time remaining till expiry date).

A few examples of corrective actions are given below however, as will be appreciated, the embodiments are not limited to those corrective actions described hereinbelow.

For example, a corrective action that could be triggered may include reducing the price of the identified product. Therefore, the application 102 may trigger the vending machine 103 to reduce the price of the identified product

Another example of a corrective action may be to give the product away for free to the next customer purchasing another product:

A corrective action may be to advertise the product and/or offers for the product to customers or potential customers. For example, customer's may be contacted or informed directly of price reductions, offers (e.g. buy one get one free, buy any product get the identified product cheaper or for free) where the customers may have subscribed to a mailing list or be within the vicinity of the vending machine that includes the identified product. The customers or potential customers may be e-mailed, may be sent a Short Message Service (SMS) message, and so on, based on a subscription list and/or based on the location of the customers or potential customers. The advertisement of the product and/or offers relating to the identified product may be via a message board or screen on the vending machine, and so on.

Therefore on identifying the product as within its predefined time period before expiry of the product the application 102 may identify one or more corrective actions to trigger.

As with the predefined time periods, the corrective actions may be set or defined in the application 102, or on a device operatively connected to the application 102, where a standard set of one or more corrective actions apply to all products, or one or more corrective actions may apply to different products, different types of products, different groups of products, how long till the expiry date (e.g. one corrective action may apply to a product four days before the expiry date of the product and another corrective action may apply to the same product two days before the expiry date of the product, and so on), etc, or any combination thereof.

As such, any number of, or combination of, corrective actions may be applied to the identified product.

The application 102 may determine or identify whether the product is out of date by, for example, comparing the current date with the expiry date of the product. If the application 102 determines that he product is out of date then the application 102 may trigger one or more corrective actions.

As described hereinabove, any number of corrective actions may be defined and those corrective actions may be defined for products, types of products, and so on.

The application 102 may identify or determine the one or more corrective actions that are associated with the product and trigger the corrective action(s).

For example, a corrective action may be to prevent the product being dispensed, by for example, triggering the vending machine to block or prevent selection of the product.

The vending machine 103 may include a bin mechanism such that out-of-date products can be automatically binned. Therefore, the application 102 could trigger, as a corrective action, the vending machine to open a bin and dispense the out-of-date product into the bin.

Another corrective action may be to trigger a request to the stockist of the vending machine 103 to visit the vending machine 103 to remove the out-of-date product.

As such, any number of, or combination of, corrective actions may be applied to the identified out-of-date product.

While preferred embodiments of the invention have been shown and described, it will be understood that such embodiments are described by way of example only. Numerous variations, changes and substitutions will occur to those skilled in the art without departing from the scope of the present invention as defined by the appended claims. Accordingly, it is intended that the following claims cover all such variations or equivalents as fall within the spirit and the scope of the invention.

1. A method, comprising:
identifying a first product that is next to be dispensed in a vending machine;
determining an expiry date of said first product; and
triggering one or more first corrective actions if a current date is within a predefined time period of said expiry date of said first product.

2. The method as claimed in claim 1, wherein said identifying said first product to be dispensed comprises:
receiving an initial position of said first product in said vending machine;
receiving information on one or more second products dispensed in said vending machine; and
tracking a position of said first product based on said received information on one or more of said second products.

3. The method as claimed in claim 1, wherein said identifying said first product to be dispensed comprises:
receiving an identification of said first product from said vending machine when said first product is next to be dispensed.

4. The method as claimed in claim 1, further comprising:
identifying said one or more first corrective actions to trigger based on one or more predefined first criteria.

5. The method as claimed in claim 1, further comprising:
triggering one or more second corrective actions if a current date is after said expiry date of said first product.

6. The method as claimed in claim 5, further comprising:
identifying said one or more second corrective actions to trigger based on one or more predefined second criteria.

7. The method as claimed in claim 1, further comprising:
periodically determining if said current date is within said predefined time period of said expiry date of said first product.

8. The method as claimed in claim 5, further comprising:
periodically determining if said current date is after said expiry date of said first product.

9. An apparatus, comprising:
a first processor configured to identify a first product that is next to be dispensed in a vending machine;
a second processor configured to determine an expiry date of said first product; and
a third processor configured to trigger one or more corrective actions if a current date is within a predefined time period of said expiry date of said first product.

10. The apparatus as claimed in claim 9, further comprising:
a first input configured to receive an initial position of said first product in said vending machine;
a second input configured to receive information on one or more second products dispensed in said vending machine; and
a fourth processor configured to track a position of said first product based on said received information on one or more of said second products.

11. The apparatus as claimed in claim 9, further comprising:
a third input configured to receive an identification of said first product from said vending machine when said first product is next to be dispensed.

12. The apparatus as claimed in claim 10, further comprising:
a fifth processor configured to identify said one or more first corrective actions to trigger based on one or more predefined first criteria.

13. The apparatus as claimed in claim 10, further comprising:
a sixth processor configured to trigger one or more second corrective actions if the current date is after said expiry date of said first product.

14. The apparatus as claimed in claim 13, further comprising:
a seventh processor configured to identify said one or more second corrective actions to trigger based on one or more predefined second criteria.

15. The apparatus as claimed in claim 14, further comprising:
an eighth processor adapted to periodically determine if said current date is within said predefined time period of said expiry date of said first product.

16. The apparatus as claimed in claim 15, further comprising:
a ninth processor configured to periodically determine if said current date is after said expiry date of said first product.

17. A computer program product comprising computer readable executable code for:
identifying a first product that is next to be dispensed in a vending machine;
determining an expiry date of said first product; and
triggering one or more corrective actions if a current date is within a predefined time period of said expiry date of said first product.

18. The method according to claim 1, wherein the determining the expiry date of the first product comprises reading information from an NFC tag.

19. The apparatus according to claim 9, wherein the second processor determines the expiry date of the first product based upon data read from an NFC tag.

20. The computer program product according to claim 17, wherein the computer readable executable code determines the expiry date of the first product based upon data provided by an NFC tag.
